(19) United States
(12) Patent Application Publication
(10) Pub. No.: US 2016/0134598 A1
(43) Pub. Date: May 12, 2016

(54) METHOD FOR PROVIDING LICENSE CORRESPONDING TO ENCRYPTED CONTENTS TO CLIENT APPARATUS AND DIGITAL RIGHTS MANAGEMENT CONVERSION SYSTEM USING THE METHOD

(71) Applicant: INTELLECTUAL DISCOVERY CO., LTD., Seoul (KR)

(72) Inventors: Sung Min AHN, Seoul (KR); Woon Sang AN, Osan (KR)

(73) Assignee: INTELLECTUAL DISCOVERY CO., LTD., Seoul (KR)

(21) Appl. No.: 14/996,983

(22) Filed: Jan. 15, 2016

Related U.S. Application Data
(63) Continuation of application No. 14/080,208, filed on Nov. 14, 2013.
Application No. 14/080,208 is a continuation of application No. 12/223,896, filed on Aug. 11, 2008, now abandoned.

(30) Foreign Application Priority Data
Feb. 13, 2006 (KR) 10-2006-0013665

(51) Int. Cl. H04L 29/06

(52) U.S. Cl. CPC H04L 63/0428; H04L 63/10

(57) ABSTRACT

Disclosed are a method for providing a license corresponding to encrypted contents to a client apparatus, which provides a license in response to a request of the license corresponding to contents super-distributed to a third person in a DRM conversion system, and a DRM conversion system using the same. First digital rights contents type first contents and a first license corresponding to the first contents are digital rights management converted to generate second digital rights contents type second contents and a second license corresponding to the second contents. A license request corresponding to the second contents super-distributed to a third person is received. A second license corresponding to the second contents super-distributed is requested from a server corresponding to the second digital right management. The second license corresponding to the second contents super-distributed is received and transmitted to the third person.

### CROSS-REFERENCE TO RELATED APPLICATIONS

This is a Continuation Patent Application of U.S. application Ser. No. 14/080,208 filed Nov. 14, 2013, which is a continuation patent application of U.S. application Ser. No. 12/223,896 filed Aug. 11, 2008 which is a national phase application of PCT/KR2007/000070 filed Jan. 5, 2007 which claims priority to Korean Patent Application No. 10-2006-0013665 filed Feb. 13, 2006 all of which are incorporated by reference herein in their entireties.

### TECHNICAL FIELD

The present invention relates to a digital rights management (referred to as ‘DRM’ hereinafter). More specifically, the invention relates to a method for providing a license corresponding to encrypted contents to a client apparatus, which provides a license in response to a request of the license corresponding to contents super-distributed to a third person in a DRM conversion system, and a DRM conversion system using the same.

### BACKGROUND ART

With the development and popularization of computer technology, most of commercial transaction copyright objects such as books, comic books, records, movies, broadcasting, or news paper manufactured, maintained, and managed in analog forms have been digitalized.

Although the digitalized commercial transaction copyright objects are repeatedly used, they are persistent high quality, and it is easy to copy and modify them. Further, it is easy to transfer and distribute even mass copyright objects within a short time. Such characteristics and advantages of a digital form cause analog copyright objects to be digitalized at high speed.

However, such advantages of digital can functions as a factor to infringe a writer's rights and advantages with copyright objects. Since a copy is identical with an original, it makes the will to buy the original weak and corrections and copying are simple without a writer's approval, it is easy to steal, transfer, and distribute the copyright object. Accordingly, illegal copyright objects are spread in a moment over Internet, with the result that it becomes impossible to legally control them.

Such negative factors reduce writer's spirit, which can reduce a manufacturing will with respect to copyright objects. In addition, they can function to cause writers to hesitate a digitalization. Accordingly, there is a demand for a technical protection device for digital copyright objects capable of efficiently managing copyrights while sufficiently maintaining advantages of a digital.

Accordingly, in order to protect benefits and rights for digital copyright objects, a technology of applying a DRM to digital contents has been proposed. Further, various DRM types have been used.

A DRM is a technique, which prevents a use of digital contents without permission in order to protect a copyright holder's benefits and rights. In general, a server providing contents using a DRM type encrypts and transmits contents, and transfers a license to allowable users so that only the allowable users can reproduce and output the contents. The license includes a contents encrypting key used for decrypting the contents and contents use rights being contents use information.

On the other hand, in the related art, a client apparatus reproduces and outputs only contents by a predetermined DRM type. Further, in the same manner, a server provides contents to a client apparatus by applying one DRM type thereto.

FIG. 1 is a view showing an embodiment of a method for providing contents to which a DRM is applied to a client apparatus according to the related art.

A client apparatus 110 is connected to a first server 120 corresponding to a first DRM type through a predetermined communication network. The first server 120 includes a contents providing server and a license issue server: When the client apparatus 110 transmits a contents providing request to the contents providing server 120, the contents providing server 120 transmits contents encrypted by a first DRM type to the client apparatus 110. The client apparatus 110 transmits a license request to the license issue server 120 corresponding to the first DRM type in order to perform a copyright of the encrypted contents. After the client apparatus 110 receives an issued license from the license issue server 120, it can use contents. That is, the client apparatus 110 decrypts, reproduces, and outputs the encrypted contents using a decrypting key included in the license.

Since the first server 120 according to the related art provides only contents encrypted by a predetermined set DRM type, it can not provide contents encrypted by other DRM types.

Furthermore, in FIG. 1, while a user reproduces contents using the client apparatus 110, when the user reproduces the same contents using a second client apparatus 130 supporting a second DRM type, he can transfer the contents from the client apparatus 110 to the second client apparatus 130. However, because the second client apparatus 130 supports a DRM type different from that of the client apparatus 110, contents transmitted to the second client apparatus 130 from the client apparatus 110 can not be reproduced.

So as to solve such problems, Korean patent publication No. 10-2005-0120579 has described an arrangement to support input and output of contents between devices of different DRM types. The patent publication is advantageous that it can be used between devices of different DRM types by converting a DRM type of contents. However, when contents to which the DRM type is converted are super-distributed to a third person, since a third person does not have a license for corresponding contents, the third person can not reproduce super-distributed contents.

Accordingly, there is a need for a method capable of obtaining a license by a third person when contents to which a DRM type is converted are super-distributed to the third person. A sever side corresponding to a DRM before conversion may participates in providing of a corresponding license for user to freely super-distribute the contents. Simultaneously, there is a demand for a DRM conversion system capable of controlling a license of contents super-distributed.

### DISCLOSURE OF INVENTION

### Technical Problem

Accordingly, the present invention has been made to solve the above-mentioned problems occurring in the prior art, and an object of the present invention is to provide a method for providing a license corresponding to encrypted contents to a client apparatus, which receives and provides the license from a sever corresponding to an encrypted DRM type to a third person in response to a request of the license when contents DRM-converted by the DRM conversion system are super-distributed to the third person and the request of the license is received from the third person, and a DRM conversion system using the same.

Further, it is another object of the present invention to receive the contents DRM-converted by a DRM conversion system through a client apparatus, to request a license corresponding to the converted contents from the DRM conversion system, and to receive the license from the server corresponding to an encrypted DRM type through the DRM conversion system.

Moreover, it is a further object of the present invention to cause a server corresponding to a DRM type prior to a DRM conversion of the contents when a client apparatus requests a license corresponding the converted contents from a DRM conversion system to recognize the request of license, and to cause a server corresponding to the DRM type prior to a DRM conversion to have an approval right for the request of the license in order to suitably control a super-distribution of the contents.

In addition, it is an object of the present invention to cause a third person requesting a license for super-distributed contents to pay an amount of money according to the license, and to cause at least one of a server corresponding to the DRM type prior to a DRM conversion, a DRM conversion system, and a server corresponding to the DRM type after a DRM conversion to suitably distributed the mount of the paid money.

### Technical Solution

In order to achieve the aforementioned objects, according to one embodiment of the present invention, there is provided an operating method of a digital rights management conversion system for providing a license corresponding to encrypted contents to client apparatus, the method comprising the steps of: (i) digital rights management converting first digital rights contents type first contents and a first license corresponding to the first contents to generate second digital rights contents type second contents and a second license corresponding to the second contents; (ii) receiving a license request corresponding to the second contents super-distributed to a third person; (iii) requesting a second license corresponding to the second contents super-distributed from a server corresponding to the second digital right management; and (iv) receiving the second license corresponding to the second contents super-distributed and transmitting the second license to the third person.

According to another aspect of the present invention, there is provided an operating method of a client apparatus for reproducing encrypted contents, the method comprising the steps of: (a) receiving contents converted to a second digital rights management type from a first digital rights management type through a digital rights management conversion system; (b) requesting a license corresponding to the contents converted into the second digital rights management type from the digital rights management conversion system; and (c) receiving a license corresponding to the converted contents into the second digital rights management type from a sever corresponding to the second digital rights management type through the digital rights management conversion system.

According to a further aspect of the present invention, there is provided digital rights management conversion system for providing a license corresponding to encrypted contents to a client apparatus, comprising: a digital rights management converter for digital rights management converting first digital rights contents type first contents and a first license corresponding to the first contents to generate second digital rights contents type second contents and a second license corresponding to the second contents; a receiver for receiving a license request corresponding to the second contents super-distributed to a third person; a license providing section for requesting a second license corresponding to the second contents super-distributed from a server corresponding to the second digital right management, and receiving the second license corresponding to the second contents super-distributed and transmitting the second license to the third person.

### BRIEF DESCRIPTION OF THE DRAWINGS

Further objects and advantages of the invention can be more fully understood from the following detailed description taken in conjunction with the accompanying drawings, in which:

FIG. 1 is a view showing an embodiment of a method for providing contents to which a DRM is applied to a client apparatus according to the related art;

FIG. 2 is a view schematically showing a network connection relation of a DRM conversion system according to an embodiment of the present invention;

FIG. 3 is a flow chart showing an operating method of a DRM conversion system according to an embodiment of the present invention;

FIG. 4 is a flow chart showing an operating method of a client apparatus according to an embodiment of the present invention;

FIG. 5 is a block diagram an internal construction of a DRM conversion according to an embodiment of the present invention; and

FIG. 6 is a block diagram of a general computer device, which can be used to perform an operating method of a DRM conversion system and an operating method of a client apparatus according to an embodiment of the present invention.

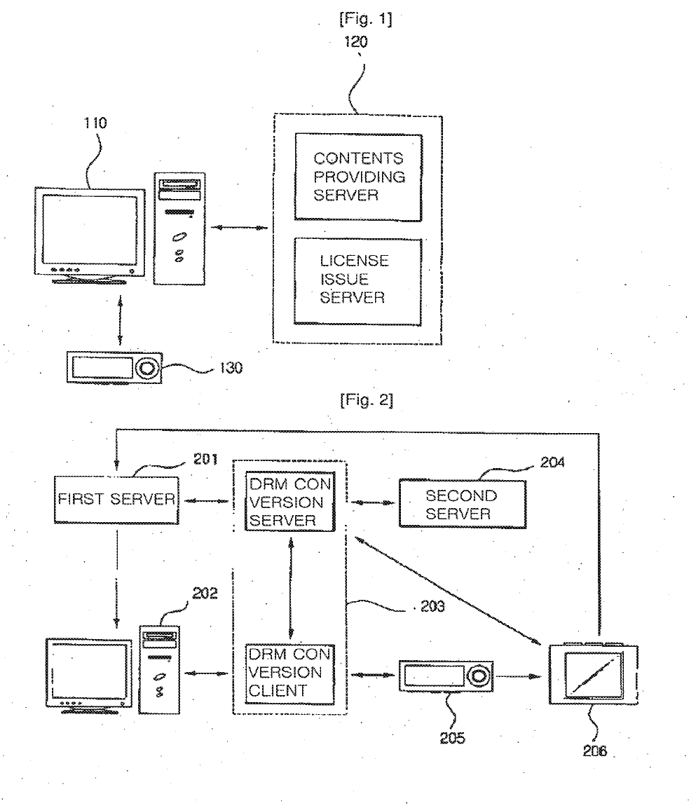

### BEST MODE FOR CARRYING OUT THE INVENTION

In the present invention, a first server is a server corresponding to a first DRM, and a second server is a server corresponding to a second DRM.

Hereafter, a method for providing a license corresponding to encrypted contents to a client apparatus and a DRM conversion system using the same according to the preferred embodiments of the present invention will be explained, with reference to the accompanying drawings.

FIG. 2 is a view schematically showing a network connection relation of a DRM conversion system according to an embodiment of the present invention.

It is assumed that a first client apparatus 202 supports a first DRM type, and a second client apparatus 205 and a third client apparatus 206 support a second DRM type.

As shown in FIG. 2, the first client apparatus 202 receives first DRM type first contents and a first license corresponding to the first contents, and reproduces the first contents. Here, a first server 201 can be a sever to provide a first DRM type contents and license.

When a user of the client apparatus 202 wants to reproduce the first contents from the second client apparatus 205, a DRM conversion system 203 DRM-converts the first DRM type first contents and a first license corresponding to the first contents to generate second DRM type second contents and a second license corresponding to the second contents. In the embodiment of the present invention, the first client apparatus 202 and the second client apparatus 205 support different DRM types, respectively. For example, the first DRM type may be an MS-DRM, and the second DRM type may be an OMA-DRM.

A DRM conversion converts the first DRM type first contents and the first license into an intermediate format, and then converts the intermediate format into the second DRM type second contents and the second license. The DRM conversion is described in Korean Patent publication No. 2005-120579 in detail.

On the other hand, when the second client apparatus 205 super-distributes the converted contents to the third client apparatus 206 being a third person, the third client apparatus 206 transmits a request of a license corresponding to the second contents to the DRM conversion system 203 for using the contents. The DRM conversion system 203 receives the request of the license, and receives and transmits the second license corresponding to the second contents super-distributed to the third client apparatus 206 from the second server 204, to the third client apparatus 206. In the embodiment of the present invention, the second client apparatus 205 and the third client apparatus 206 supports the same DRM type.

Here, the super distribution means to separately distribute contents and licenses. A user can distribute contents used by himself to a third person through a super-distribution. The third person having received the contents obtains a license regardless of the contents and uses the distributed contents.

Here, the third client apparatus 206 having requested the license can request an approval from the first server 201 together with the request of the license. When the DRM conversion system 203 receives the request of the license from the third client apparatus 206, it can request a license issue approval for corresponding contents from the first server 201.

When the DRM conversion system 203 receives the license request from the third client apparatus 206 and requests a license issue approval for corresponding contents from the first server 201, a DRM conversion server can discriminate the first server 201 corresponding to a DRM type prior to a conversion of contents in which a license is requested by referring a conversion log database.

That is, the. DRM conversion system 203 records a log regarding a DRM conversion every a DRM conversion in a conversion log database. When the DRM conversion system 203 receives a license request for special contents, it may discriminate the DRM server corresponding to a DRM prior to a conversion of corresponding contents by referring a conversion log database.

The DRM conversion system 203 may be constituted of a DRM conversion server and a DRM conversion client. Namely, partial arrangements of the DRM conversion system 203 can be included in the DRM conversion server, and remaining arrangements can be included in the DRM conversion client.

In the embodiment, the DRM conversion system 203 may include only the DRM conversion server without having the DRM conversion client. In this case, the DRM conversion server performs all functions of the DRM conversion system 203.

Each of the client apparatuses 202, 205, and 206 according to the present invention may include PC, Personal Digital Assistant (PDA), smart phone, handheld PC, portable phone, MP3 player, predetermined communication module such as code division multiplexing access module, Bluetooth module, infrared rays communication module (IrDA), wire/wireless LAN card, and can mount a predetermined micro-processor for performing a multimedia reproducing function in order to perform predetermined calculation performances.

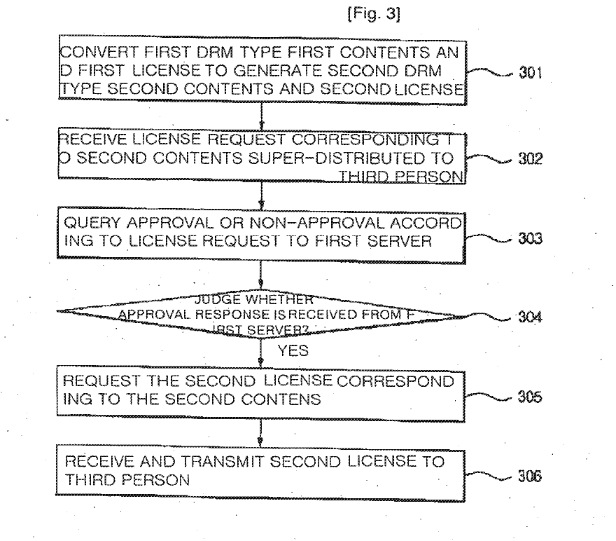

FIG. 3 is a flow chart showing an operating method of a DRM conversion system according to an embodiment of the present invention.

In step 301, the DRM conversion system converts first DRM type first contents and a first license corresponding to the first contents in order to generate second DRM type second contents and a second license corresponding to the second contents. For example, the DRM conversion system may convert first DRM type first contents “loved” and a first license corresponding to the first contents “loved” in order to generate second DRM type second contents “loved” and a second license corresponding to the second contents “loved”.

In the embodiment of the present invention, the DRM conversion system can record a DRM conversion log in a database. For example, the DRM conversion log may include first contents, DRM conversion information according to a DRM conversion of a first license corresponding to the first contents, or server information for issuing a license with respect to the first contents.

Moreover, in another embodiment of the present invention, a part of the DRM conversion system can be installed at a client terminal.

In step 302, the DRM conversion system receives the license request corresponding to the second contents super-distributed to the third person. That is, in the present invention, because the third person receives only the second contents from the client apparatus providing the second contents, the third person requests a license corresponding to the second contents from the DRM conversion system.

In this case, when a server corresponding to the DRM type prior to the conversion is cancelled, and the second license corresponding to the second distributed contents is issued, it results in unsuitable ignore of a contents source.

In step 303, the DRM conversion system queries an approval or a non-approval according to the license request to the first server. Namely, since the license is obtained by converting a first license corresponding to the first DRM type first contents, and the first license is issued from the first server, the DRM conversion system queries an approval or a non-approval according to the license request. Further, the DRM conversion system can discriminate the first server by referring the database in which the DRM conversion log is recorded.

In the embodiment, the DRM conversion system does not query an approval or a non-approval according to the license request, but the third person side can request an approval from the first server together with the license request. At this time, the DRM conversion system can provide first server information corresponding to a DRM type prior to a conversion to the third person side.

When an approval response is received from the first server (step 304), the DRM conversion system requests a second license corresponding to the second contents super-distributed to the third person from the second server (step 305).

In step 306, the DRM conversion system receives the second license corresponding to the second contents super-distributed from the second server and transmits the second license to the third person.

In the embodiment of the present invention, when the DRM conversion system receives an approval response from the first server, it can receive an allotment of a predetermined amount of money billed by the third person from the first server. Moreover, the DRM conversion system may provide a part of the amount of the allotted money to the second server.

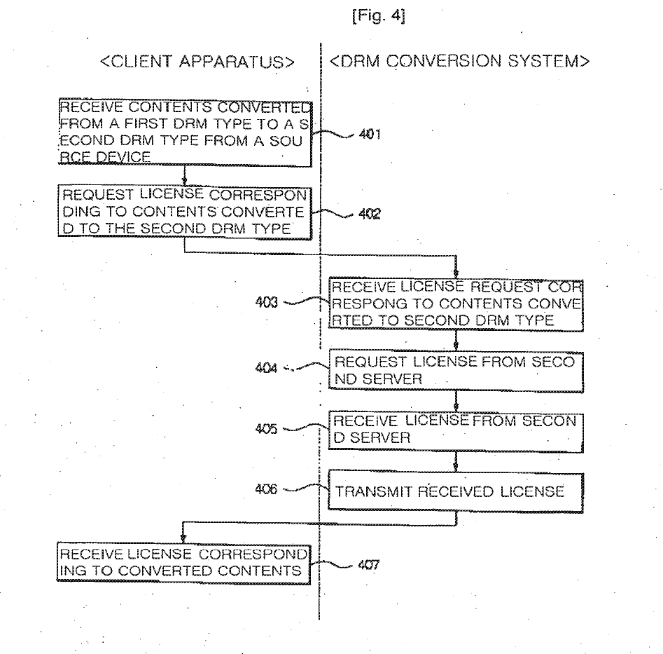

FIG. 4 is a flow chart showing an operating method of a client apparatus according to an embodiment of the present invention.

In step 401, the client apparatus receives the contents from a source device through a predetermined DRM conversion. Here, the contents are contents, which are converted from a first DRM type to a second DRM type. For example, the source device super-distributes music contents “loved” converted to a “DRM 2” type from a “DRM 1” to the client apparatus being a third person through the DRM conversion system. Accordingly, the client device can receive the music contents “loved” converted to a “DRM 2” type.

In step 402, the client apparatus requests a license corresponding to the contents converted to the second DRM type from the DRM conversion system.

In the embodiment of the present invention, the client apparatus can transmit an approval request corresponding to the license request to the first server. Moreover, the DRM conversion system may transmit a license issue approval request corresponding to the license request to the first server.

In step 403, the DRM conversion system receives a license request corresponding to contents converted to the second DRM type.

In step 404, when the DRM conversion system receives an approval response from the first server corresponding to the first DRM type, it transmits a license request for the contents to the second server.

In step 405, the DRM conversion system receives a license for the contents from the second server.

In step 406, the DRM conversion system transmits the received license to the client apparatus.

In step 407, the client apparatus receives a license corresponding to the converted contents from the second server through the DRM conversion system.

In the embodiment of the present invention, the client apparatus can pay at least one of the server corresponding to the first DRM type, the DRM conversion system, and a server corresponding to the second type a predetermined amount of money for the license corresponding to the converted contents. Here, any one of the server corresponding to the first. DRM type, the DRM conversion system, and a server corresponding to the second type receives the payment of the predetermined amount of money, and the server (or system) having received the payment may allot a predetermined amount of money to other servers (systems).

According to the embodiment of the present invention, the license corresponding to the converted contents are issued from the server corresponding to the second DRM type, and can include one of the decrypting key for the second DRM type contents or usage right information for the contents.

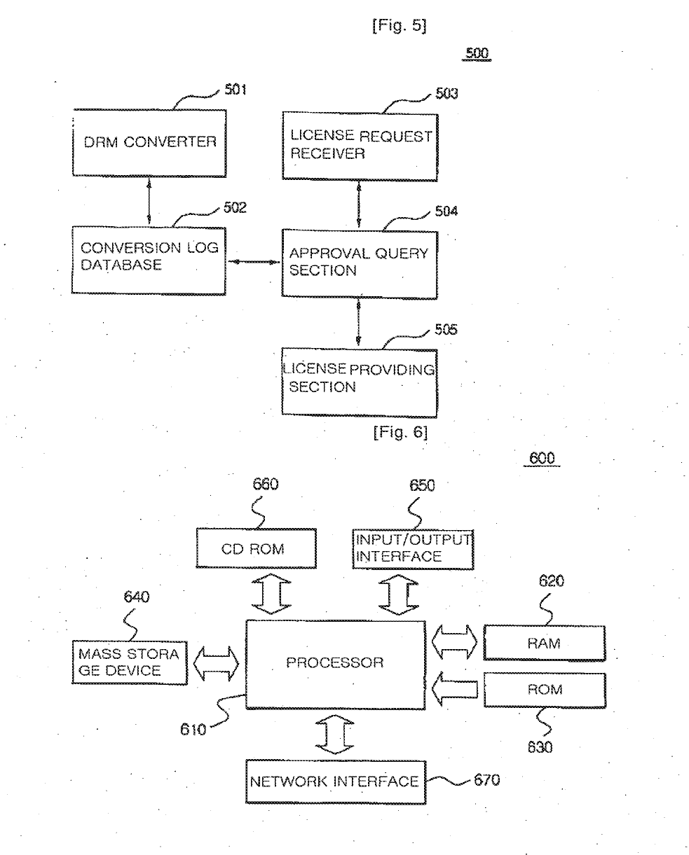

FIG. 5 is a block diagram an internal construction of a DRM conversion according to an embodiment of the present invention.

As shown in FIG. 5, the DRM conversion system 500 includes a DRM converter 501, a conversion log database 502, a license request receiver 503, an approval query section 504, and a license providing section 505. In the embodiment of the present invention, a part of the DRM conversion system 500 can be installed at a client terminal.

The DRM converter 501 converts the first DRM type first contents and the first license corresponding to the first contents in order to generate the second DRM type second contents and the second license corresponding to the second contents.

In the embodiment of the present invention, the DRM converter 501 may record the

DRM conversion log according to the DRM conversion in the conversion log database 502.

The license request receiver 503 receives a license request corresponding to the second contents, which are super-distributed to the third person.

In the embodiment of the present invention, the approval query section 504 queries the first server corresponding to the DRM type prior to a conversion on an approval or a non-approval according to the license request. Furthermore, the approval query section 504 can discriminate the first server by referring the conversion log database in which the DRM conversion log is recorded.

When the license providing section 505 receives an approval, it requests the second license corresponding to the second contents super-distributed to the third person from the second server, and receives and transmits the second license corresponding to the second contents super-distributed to the third person.

The operating method of the DRM conversion system and the operating method of the client apparatus according to the present invention can be embodied with a program command pattern capable of being performed through various computer means and be recorded in a computer readable medium. The computer readable medium can includes one or combination of a program command, a data file, and a data structure. The program command recorded in the computer readable medium is specially designed and constructed for the present invention, but is disclosed to a person having ordinary skill in the computer software art and is used. There is a hardware device constructed to store and perform program commands, which include magnetic media such as hard disks, floppy disks, or magnetic tapes, optical media such as CR-ROM or DVD, magneto-optical media such floptical disks, ROM, RAM, or flash memories. The computer readable medium may be transfer medium such as optical lines, metal lines, or waveguides including a carrier wave for transmitting a signal designating the program command and the data construction. There are machine language codes and high-level language codes as an example of the program commands. Here, the machine language codes are made by a compiler, and the high-level language codes can be executed by a computer using an interpreter. The hardware device can be constructed to be operated as at least one software module in order to execute operations of the present invention, and the converse is the same.

FIG. 6 is a block diagram of a general computer device, which can be used to perform an operating method of a DRM conversion system and an operating method of a client apparatus according to an embodiment of the present invention.

The computer device 600 includes at least one processor 610. The at least one processor 610 is connected to a main storage device including a random access memory (RAM) 620 and a read only memory (ROM) 630. The processor 610 is called central processing unit (CPU). As well known in the art, the ROM 630 functions to unilaterally transmit data and commands to the CPU, and the RAM is used to bi-laterally transmit the data and the commands to the CPU. The RAM 620 and the ROM 630 can include any suitable form of the computer readable media. A mass storage device 640 is bilaterally connected to the processor 610, and provides an additional data storage performance, and may one of the aforementioned computer readable media. The mass storage device 640 is used to store programs and data, and may be an auxiliary storage device such a hard disk having a speed lower than that of the main storage device. Also, the mass storage device such as CD ROM 660 can be used. The processor 610 is connected to at leas one input/output interface 650. The input/output interface 650 includes video monitors, a track balls, mice, keyboards, microphones, touch screen type display devices, card readers, magnetic or paper readers, voice or writing detectors, joy sticks, or disclosed input/output devices for a computer. Finally, the processor 610 can be connected to wire or wireless communication network through a network interface 670. The procedure of the aforementioned method can be performed through the network connection. The device and tool are well known to a person having ordinary skill in the computer hardware or software art. On the other hand, the aforementioned hardware device can be constructed to be operated as at least one software module in order to perform an operation of the present invention.

While the present invention has been described with reference to several preferred embodiments, the description is illustrative of the invention and is not construed as limiting the invention. Various modifications and variations may occur to those skilled in the art, without departing from the scope and spirit of the invention, as defined by the appended claims.

### INDUSTRIAL APPLICABILITY

According to the DRM conversion system of the present invention, when the DRM converted contents are super-distributed to a third person, and a license request corresponding to the contents is received from the third person, the DRM conversion system receives the license from a server corresponding to an encrypted DRM type according to the license request, and provides the license to the third person.

Furthermore, in the present invention, a client apparatus receives contents DRM converted through a predetermined DRM conversion system from a first client apparatus, may request a license corresponding to the converted contents from the DRM conversion system and receive the license from a server corresponding to an encrypted DRM type through the DRM conversion system.

Moreover, in the present invention, when the client apparatus requests a license corresponding to the converted contents from the DRM conversion system, it causes a server corresponding to a DRM type prior to a DRM conversion of the contents to recognize a license request fact. This causes the server corresponding to the DRM type prior to a DRM conversion to have an approval right for a license request in order to suitably control a super-distribution of the contents.

In addition, the present invention causes a third person having requested the license for the super-distributed contents to pay an amount of money corresponding to a corresponding license, and at least one of the server corresponding to the DRM type prior to the DRM conversion, the DRM conversion system, and the server corresponding to the DRM type after the DRM conversion can suitably distribute an amount of the paid money.

What is claimed:

1. A content transmission method between devices having different DRM (Digital Rights Management) manners comprising:
receiving, by a first device, a content encrypted by a first DRM manner and a license of the first DRM manner from a first server;
converting, by the first device, the content encrypted by the first DRM manner into a content of intermediate format;
receiving, by a second device, the content of the intermediate format from the first device; and
converting, by the second device, the content of the intermediate format into a content according to a second DRM manner that the second device maintains,
wherein the converting in the second device is performed by using an encryption key for the content shared with the first device.

2. The method of claim 1 wherein the first and the second device comprises a DMA converter configured to convert the content's DRM manner through the intermediate format using the encryption key.

3. The method of claim 2, wherein the first and the second device further comprises a license providing section configured to generate the license according to specific DRM manner through the intermediate format,
and wherein the converting by the first device comprises converting the content encrypted by the first ORM manner and the license of the first DRM manner into the content and a license of intermediate format,
and wherein the receiving by the second device comprises receiving, by a second device of the same account as well as a user of the first device, the content and the license of the intermediate format from the first device;
and wherein the converting by the second device comprises converting the content and license of the intermediate format into the content and license according to a second DRM manner that the second device maintains,
and wherein the license comprises at least one of encryption key and use right information.

4. The method of claim 3, wherein the first and the second device further comprises:
a reproducing unit configured to reproduce the content according to the DRM manner suitable for the first or the second device.

5. The method of claim 3, wherein the first device decides whether a user account of the second device is same as well as that of the first device,
and wherein when a second device of the same account as well as a user of the first device, the first device converts the content and the license of the first DRM manner into the intermediate format and transmits the content and the license of the intermediate format to the second device.

6. The method of claim 3, wherein when the content is transmitted from the second device to a third device of a third party who has a different account from the user of the first device, the third device receives the content according to the second ORM manner directly from the second device without the license for the content.

7. The method of claim 6, wherein the first or the second device further comprises a conversion log database that stores a log data for ORM conversion for the content,
and wherein the third device receives the license for the content according to the second ORM manner through an approval of the first server, using the log data included in the first or the second device.

8. A content transmission system between devices having different DRM (Digital Rights Management) manners,
a content provider configured to transmit a content encrypted by a first DRM manner and a license of the first ORM manner to a first device;
a first device configured to receive the content encrypted by the first DRM manner and the license of the first ORM manner from a first server, convert the content into a content of intermediate format and transmit the content of intermediate format to a second device; and
a second device configured to receive the content of the intermediate format from the first device and convert the content of the intermediate format into a content according to a second ORM manner that the second device maintains,
wherein the second device converts the content by using an encryption key for the content shared with the first device.

9. The system of claim 8, wherein the first and the second device comprises a DRM converter configured to convert the content's ORM manner through the intermediate format using the encryption key.

10. The system of claim 9, wherein the first and the second device further comprises a license providing section configured to generate the license according to specific DRM manner through the intermediate format,
and wherein the first device converts the content encrypted by the first ORM manner and the license of the first ORM manner into the content and a license of intermediate format,
and wherein the second device of the same account as well as a user of the first device receives the content and the license of the intermediate format from the first device;
and wherein the second device converts the content and license of the intermediate format into the content and license according to a second DRM manner that the second device maintains,
and wherein the license comprises at least one of encryption key and use right information.

11. The system of claim 10, wherein the first and the second device further comprises:
a reproducing unit configured to reproduce the content according to the DRM manner suitable for the first or the second device.

12. The system of claim 10, wherein the first device decides whether a user account of the second device is same as well as that of the first device,
and wherein when a second device of the same account as well as a user of the first device, the first device converts the content and the license of the first DRM manner into the intermediate format and transmits the content and the license of the intermediate format to the second device.

13. The system of claim 10, wherein when the content is transmitted from the second device to a third device of a third party who has a different account from the user of the first device, the third device receives the content according to the second ORM manner directly from the second device without the license for the content.

14. The system of claim 13, wherein the first or the second device further comprises a conversion log database that stores a log data for ORM conversion for the content,
and wherein the third device receives the license for the content according to the second DRM manner through an approval of the first server, using the log data included in the first or the second device.
